(19) United States
(12) Patent Application Publication
(10) Pub. No.: US 2023/0335774 A1
(43) Pub. Date: Oct. 19, 2023

(54) Battery Assembly Device

(71) Applicants: Hyundai Motor Company, Seoul (KR); Kia Corporation, Seoul (KR)

(72) Inventors: Jae Ho Chun, Busan (KR); Hyun Jun Yoon, Goyang-si (KR)

(21) Appl. No.: 18/062,975

(22) Filed: Dec. 7, 2022

(30) Foreign Application Priority Data
Apr. 14, 2022 (KR) 10-2022-0046038

(51) Int. Cl. H01M 10/04

(52) U.S. Cl. CPC H01M 10/0404

(57) ABSTRACT

In accordance with an embodiment, a battery assembly device includes a holder unit configured to hold a structure and to transfer the structure to a target to be mounted, an alignment jig operatively associated with the holder unit, and configured to align the target, and a transfer unit configured to provide a moving force to the alignment jig.

### CROSS-REFERENCE TO RELATED APPLICATIONS

The present application claims priority to Korean Patent Application No. 10-2022-0046038, filed Apr. 14, 2022, the entire contents of which are incorporated herein for all purposes by this reference.

### TECHNICAL FIELD

The present disclosure relates to a battery assembly device.

### BACKGROUND

Generally, a battery as an energy storage device is used in various fields. For example, a battery is configured to provide energy required to drive an eco-friendly vehicle, such as an electric vehicle, which has recently been attracting attention.

In a battery of an eco-friendly vehicle, a module is constituted by a plurality of battery cells to make a high-voltage and high-capacity battery required to drive the vehicle, and the plurality of modules are assembled with each other and are finally manufactured in the form of a battery pack mounted on the vehicle. Specifically, as illustrated in FIGS. 1A to IC, a predetermined number of unit cells C are joined to each other to form a cell stack A, and the cell stack A is assembled to form a module M of a required capacity.

### SUMMARY

According to an aspect of the present disclosure, there is provided a battery assembly device including: a holder unit configured to hold a structure and to transfer the structure to a target to be mounted; an alignment jig operatively associated with the holder unit, and configured to align the target; and a transfer unit configured to provide a moving force to the alignment jig.

According to another aspect of the present disclosure, the battery assembly device includes: the holder unit gripping at least one sensing block of two sensing blocks connected to each other such that the at least one sensing block is rotatable relative to a pivot shaft; the alignment jig configured to align leads of a cell stack in which a plurality of battery cells is stacked; the transfer unit to which the alignment jig is movably mounted; and a controller configured to control operations of the holder unit and the transfer unit, wherein the controller is configured to control the holder unit and the transfer unit such that the alignment jig aligns the leads while the leads are inserted into the sensing block.

According to the present disclosure, a battery assembly device that can simplify a battery assembly process is provided.

According to the present disclosure, a battery assembly device, which can reduce manual work required during a battery assembly, is provided.

According to the present disclosure, a battery assembly device which can ensure safety during a battery assembly is provided.

Effects of the present disclosure are not limited to the effects described above, and other effects not mentioned will be clearly recognized by those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1A illustrates a cell of a battery, FIG. 1B illustrates a cell stack in which a plurality of cells such as the cell of FIG. 1A are stacked on each other, and FIG. 1C illustrates the assembled battery module of the cell stack of FIG. 1B;

FIG. 2A illustrates a sensing block mounted on the cell stack during the assembly of a module;

FIG. 2B illustrates the mounted state of the sensing block to the cell stack;

FIG. 3 illustrates one assembly form of the cell stack;

FIG. 4 illustrates the operation of an alignment jig configured to align leads of cells prior to the mounting of a sensing block;

FIG. 5A illustrates an exemplary sensing block structure body applicable to a battery assembly device according to the present disclosure;

FIG. 5B is a top plan view of FIG. 5A;

FIG. 6 is a front view of the battery assembly device according to the present disclosure;

FIG. 7 is a left side view of FIG. 6;

FIG. 8A illustrates a perspective view of a holder unit of the battery assembly device according to the present disclosure;

FIG. 8B illustrates an adsorption part of the holder unit in more detail;

FIGS. 8C and 8D are perspective views of a grip part of the holder unit;

FIGS. 9A to 9C illustrate a process in which the sensing block structure body is mounted on the cell stack by the battery assembly device according to the present disclosure;

FIGS. 10A and 10B illustrate a portion of the mounting process of the alignment jig by a transfer unit of the battery assembly device according to the present disclosure;

FIG. 10C is a front view of FIG. 10B;

FIG. 10D is a front view of the battery assembly device according to the present disclosure;

FIGS. 11A to 11C illustrate a process of mounting a sensing block by the cooperative operation of the holder unit and the transfer unit of the battery assembly device according to the present disclosure;

FIG. 12A illustrates the appearance of the sensing block when the sensing block is viewed from the cell stack;

FIG. 12B illustrates the appearance of the sensing block rotated by the holder unit when the sensing block is viewed from the cell stack; and

FIG. 13 illustrates the configuration diagram of a control system of the battery assembly device according to the present disclosure.

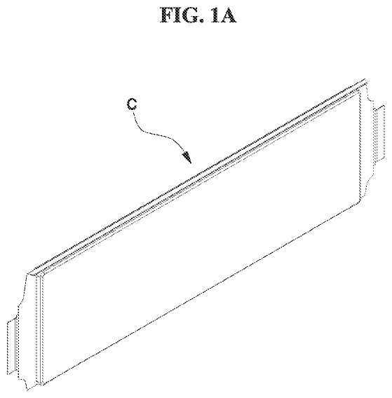

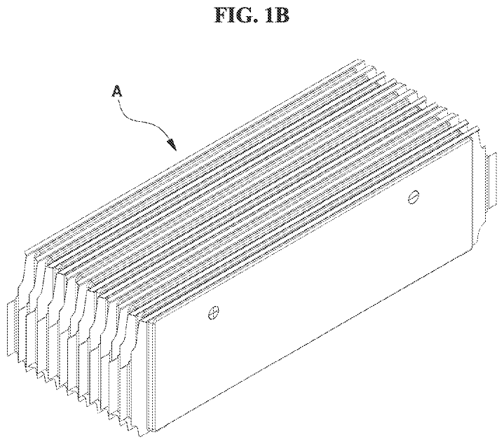

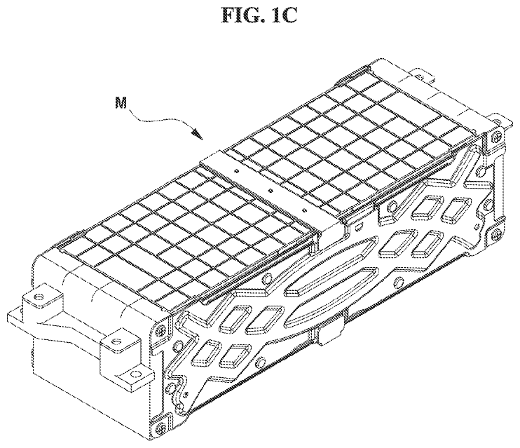

### DETAILED DESCRIPTION OF ILLUSTRATIVE EMBODIMENTS

Specific structural or functional descriptions presented in the embodiment of the present disclosure is only exemplified for the purpose of describing the embodiment according to the concept of the present disclosure, and the embodiment according to the concept of the present disclosure may be implemented in various forms. In addition, the present disclosure should not be construed as being limited to the embodiment described herein, and should be understood to include all modifications, equivalents, and substitutes included in the spirit and scope of the present disclosure.

Meanwhile, in the present disclosure, terms such as first and/or second may be used to describe various components, but the components are not limited to the above terms. The above terms are used only for the purpose of distinguishing one component from other components. For example, within the scope not departing from the scope of the claims according to the concept of the present disclosure, a first component may be referred to as a second component, and similarly, the second component may also be referred to as the first component.

When a component is referred to as being “connected” to another component, it should be understood that it may be directly connected to another component, but other components may exist therebetween. On the other hand, when it is mentioned that a certain element is “directly connected” or “directly contacted” with another element, it should be understood that no other element is present therebetween. Other expressions for describing the relationship between elements, that is, expressions such as “between” and “immediately between” or “adjacent to” and “directly adjacent to” should be interpreted similarly.

Like reference numerals refer to like elements throughout. On the other hand, terms used herein are for the purpose of describing the embodiment and are not intended to limit the present disclosure. In this specification, a singular form also includes a plural form unless otherwise specified in the phrase. As used herein, “comprises” and/or “comprising” means that a stated component, step, operation and/or element does not exclude the presence or addition of one or more other components, steps, operations and/or elements.

Hereinafter, the present disclosure will be described in detail with reference to the accompanying drawings.

In some embodiments, a battery assembly device may be used to simplify the assembly process of a battery during the manufacturing of the battery. The objectives of the present disclosure are not limited to the objectives mentioned above, and other objectives not mentioned are clearly understood by those skilled in the art (hereinafter referred to as “a person of ordinary skill”) to which the present disclosure belongs from the following description.

During the assembly of a module M by using a cell stack A, for the electrical connection of each of cells C to each other, processes, such as the assembly of a sensing block, the bending of leads, and laser welding, may be implemented. The sensing block (an interconnect board, ICB) is a module which provides a series connection structure of positive and negative poles between each cell (C) of a battery. First, referring to FIG. 2A, the leads L of cells C are aligned, and the sensing block ICB for the electrical connection of the cells C to each other is assembled with the cells. In addition, as illustrated in FIG. 2B, the leads L of cells C are bent and are connected to the sensing block ICB, and the connected leads L are welded thereto by laser.

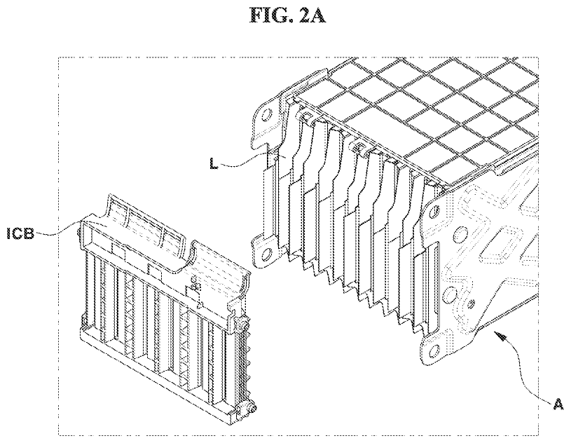

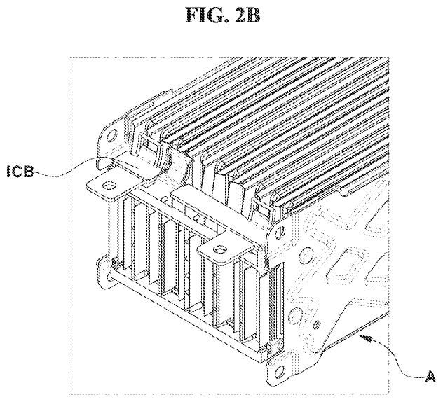

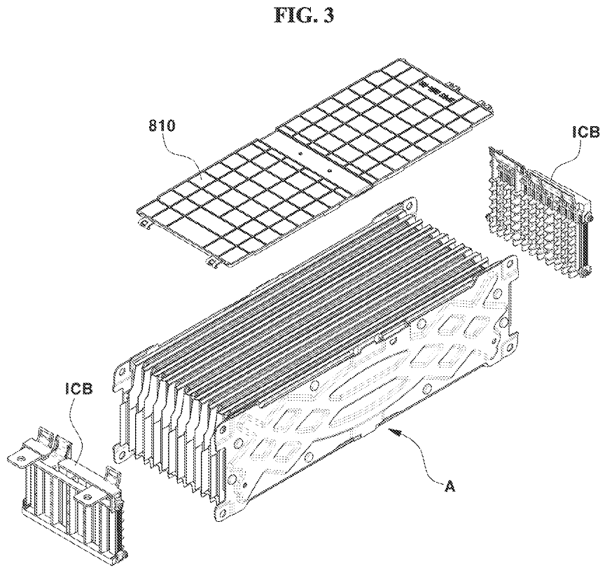

Accordingly, the manufacturing of a module M by using cells C, and the manufacturing of a battery pack require a large amount of manual work. For example, as illustrated in FIG. 3, during the assembly process of the battery pack, the sensing block ICB is required to be assembled with each of the opposite ends of each module M, and a cover 810 is separately required to be mounted thereon. Additionally, for electrical connection of each part, a connector is required to be inserted into the module and wiring is required to be performed. Such work is required to be performed for dozens of modules when assembling one battery pack, and ultimately, this process may lower a utilization rate due to excessive manual labor and cause quality problems.

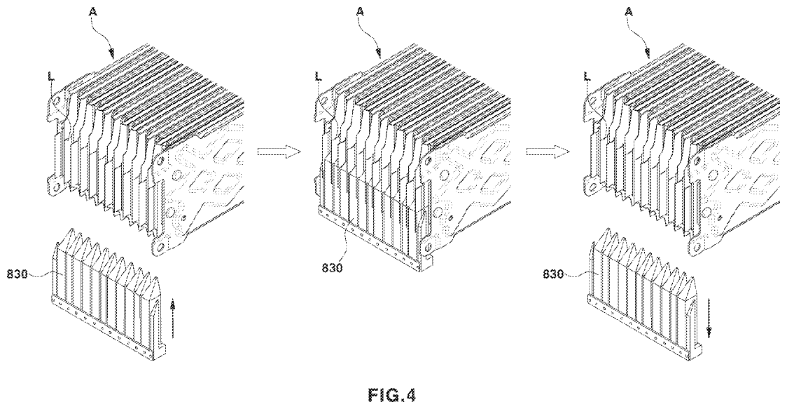

Referring to FIG. 4, in the process of aligning leads L having flexibility, after an alignment jig 830 moves upward, aligns the leads L, and moves downward, the sensing block ICB is assembled. That is, since no alignment jig 830 is present between the sensing block ICB and the leads L, the sensing block ICB and the leads L may collide with each other during the insertion of the sensing block ICB, and in this case, when the leads are bent, fire may occur.

Accordingly, embodiments of the present disclosure provide a battery assembly device which can simplify a battery assembly process and can align leads safely.

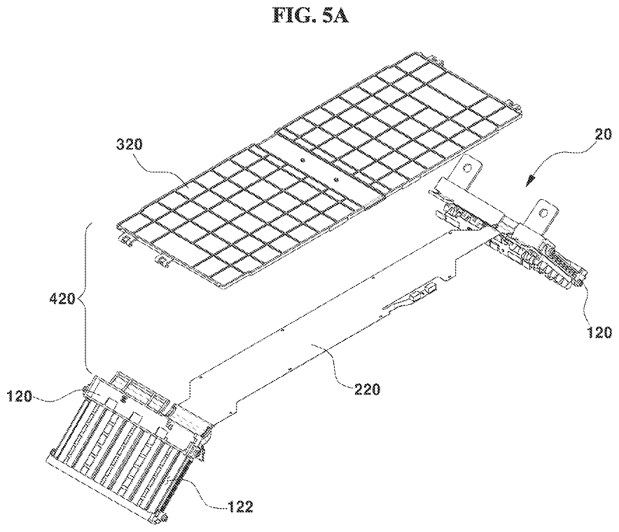

Referring to FIGS. 5A and 5B, the battery assembly device according to the present disclosure may assemble a sensing block structure body 20, which are prepared in advance, with the cell stack A. In an embodiment, the sensing block structure body 20 includes two sensing blocks 120 and a link 220.

The sensing blocks 120 are respectively assembled with the opposite ends of the cell stack A, and are configured to electrically connect each of the cells C to each other. The link 220 extending between the two sensing blocks 120 is configured to connect the opposite sensing blocks 120 to each other. In an embodiment, the link 220 may include a flexible printed circuit board (FPCB) or wire.

In addition, the sensing block structure body 20 may include a cover 320. The cover 320 is configured to connect the opposite sensing blocks 120 to each other. The cover 320 allows each of the sensing blocks 120 to be coupled rotatably to the cover 320. In some embodiments, a hinge coupling part 420 may be provided between the cover 320 and the sensing block 120. In addition, the cover 320 may connect each of the sensing blocks 120 to each other so as to cover the link 220 and the cell stack A.

As illustrated in FIG. 5B, in an embodiment, the cover 320 may include grooves 520. Each of the grooves 520 may be a through hole passing through the entirety of the cover 320 in a thickness direction, and may be a groove which does not pass therethrough. The groove 520 may be used as a part adsorbed by an adsorption part 140 to be described later.

In the battery assembly device according to the present disclosure, one sensing block structure body 20 is configured to be assembled with each cell stack A, and thus the two sensing blocks 120 and the cover 320 may be simultaneously assembled with the cell stack A.

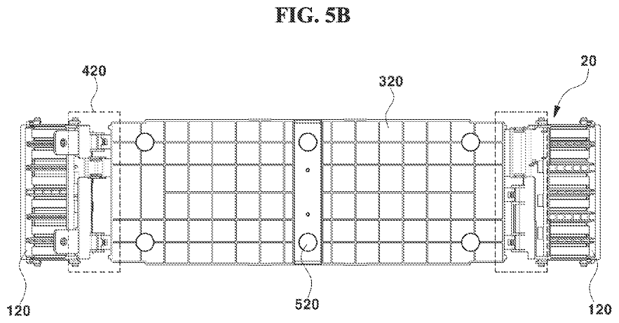

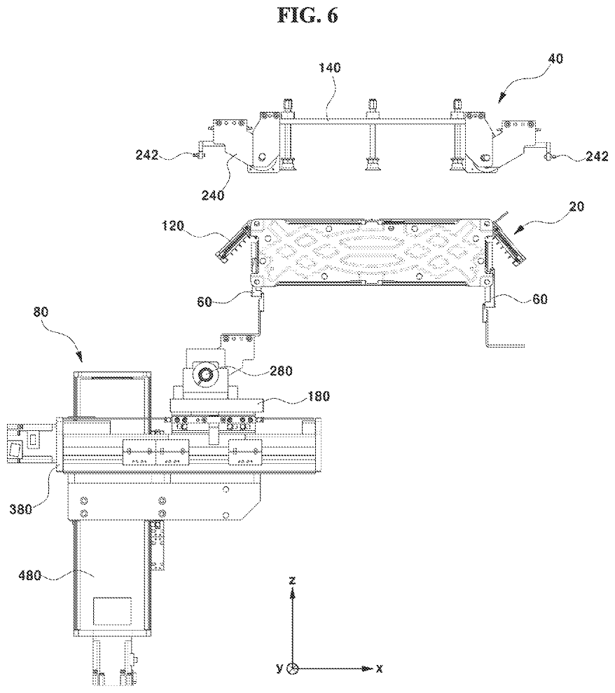

Referring to FIGS. 6 and 7, the battery assembly device according to the present disclosure includes a holder unit 40 and a transfer unit 80.

The holder unit 40 is configured to move the sensing block structure body 20 to be mounted to the cell stack A. For example, the holder unit 40 is a mechanical arm configured to be movable and rotatable in x, y, and z-axial directions in an assembly line. That is, the holder unit 40 may be configured to move in a multi-axial direction. Particularly, the holder unit 40 is configured to rotate the sensing block 120 by holding the sensing block 120 of the sensing block structure body 20 such that the sensing block 120 can be mounted to the cell stack A.

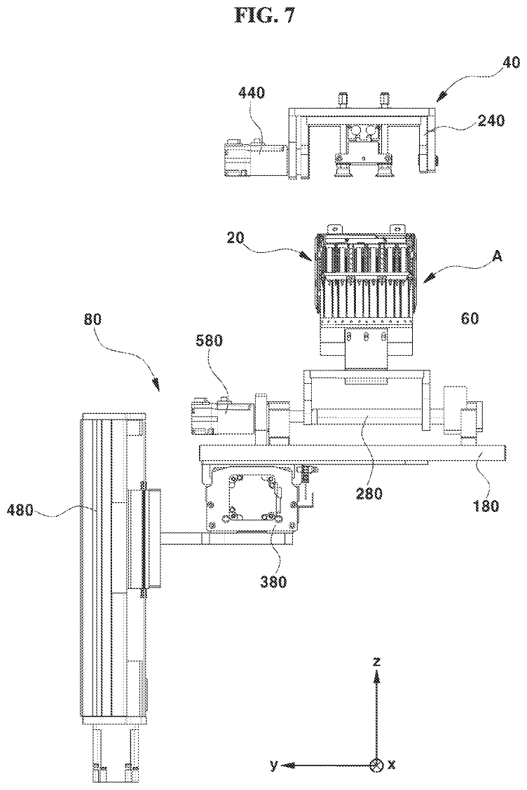

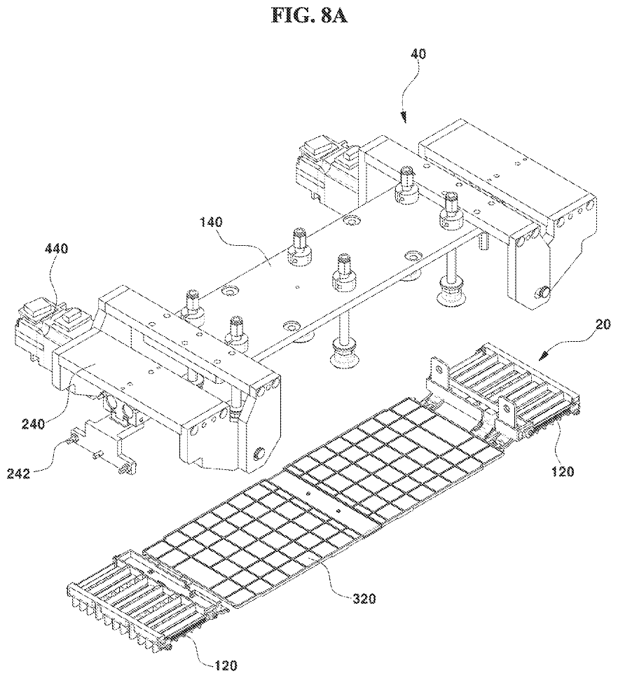

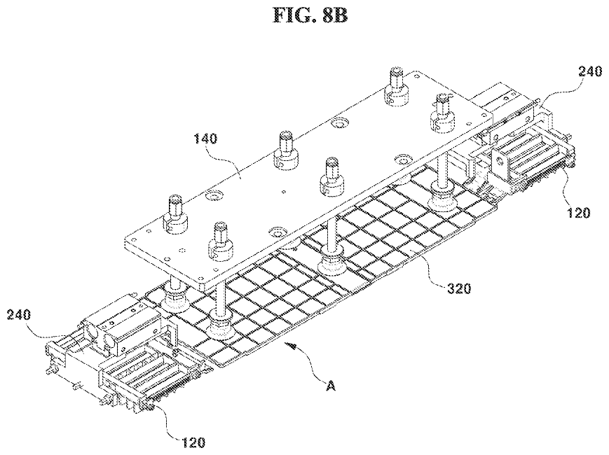

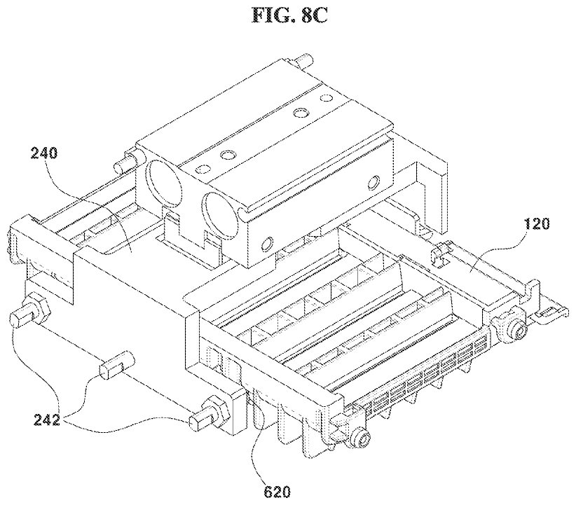

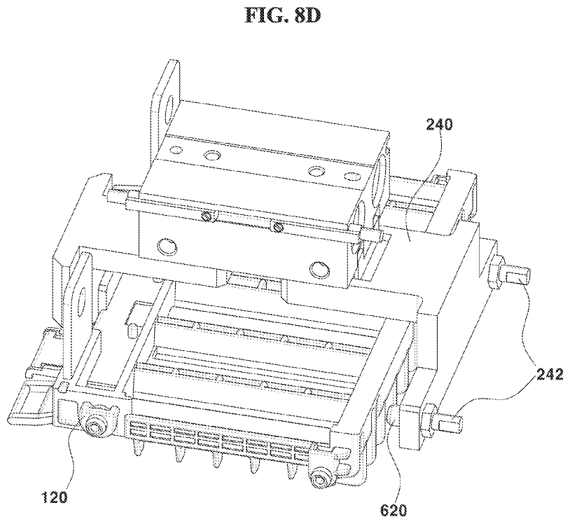

Referring to FIGS. 8A to 8D, specifically, the holder unit 40 includes the adsorption part 140. The adsorption part 140 is configured to adsorb the sensing block structure body 20 or the cover 320. For instance, the adsorption part 140 may perform vacuum adsorption. In some embodiments, the adsorption part 140 is configured to adsorb the cover 320 through the groove 520.

In addition, the holder unit 40 includes the grip part 240. The grip part 240 is configured to grip the sensing block 120. The adsorption part 140 holds the cover 320 through adsorption, and the grip part 240 grips the sensing block 120 located on each of the opposite ends of the cover 320. The grip part 240 may be provided as many as the number of the sensing blocks 120, and two grip parts 240 may be preferably provided. The sensing block 120 is hingedly connected to the sensing block structure body 20, so during the transfer and assembly of the sensing block, the sensing block may be required to be regulated. Accordingly, in the present disclosure, the cover 320 of the sensing block structure body 20 is held by the adsorption part 140, and the sensing block 120 of the sensing block structure body 20 is held by the grip part 240, so the cover 320 and the sensing block 120 may be prevented from being dislocated during the transfer and assembly thereof.

According to an embodiment of the present disclosure, the grip part 240 may include grip rods 242. When the grip part 240 grips the sensing block 120, each of the grip rods 242 may be configured to be inserted into a grip hole 620 formed in the sensing block 120. As well illustrated in FIGS. 8C and 8D, the grip rods 242 formed in the grip parts 240, respectively, may be provided to be different from each other in number and position. For example, a grip part 240 located at a first side may include three grip rods 242, and a grip part 240 located at a second side which is opposite side to the first side may include two grip rods 242.

Correspondingly, the grip holes 620 of the sensing blocks 120 provided in one sensing block structure body 20 may be provided as many as the same number as the number of the grip rods 242 formed respectively in the grip parts 240. In some embodiments, the grip rods 242 formed in each of the grip parts 240 may be disposed at different positions, and the grip holes 620 provided in the sensing block 120 may be disposed at different positions such that the grip rods 242 of each of the grip parts 240 are inserted respectively into the grip holes 620. In order to check correct positions of the grip rods and to prevent wrong insertion thereof even after the grip part 240 grips the sensing block, the grip holes 620 and the grip rods 242 may be provided to be different in number and position at each of the opposite sides.

The grip part 240 is connected to the adsorption part 140 such that the grip part 240 is rotatable relative to the adsorption part 140. A pivot shaft 340 is provided between the grip part 240 and the adsorption part 140, and the grip part 240 may pivot around the pivot shaft 340 with respect to the adsorption part 140.

The holder unit 40 further includes a driving part 440. In an embodiment, the driving part 440 may be a servomechanism including a servomotor. The driving part 440 may provide a driving force to the grip part 240 such that the grip part 240 can rotate relative to the pivot shaft 340, and may rotate the grip part 240 by a preset angle.

The cell stack A is aligned by the alignment jig 60. Specifically, as described above, the alignment jig 60 functions to align the leads L of the cell stack A. For example, the alignment jig 60 may include alignment parts 160 like gaps such that the leads L are respectively inserted into the alignment parts 160.

Referring back to FIGS. 6 and 7, the alignment jig 60 is mounted to the transfer unit 80, and the transfer unit 80 is configured to adjust the position of the mounted alignment jig 60. Particularly, the transfer unit 80 allows the positions of leads L to be adjusted and may adjust the angle of the alignment jig 60. In an embodiment, the alignment jig 60 may be mounted to a moving plate 180 provided in the transfer unit 80 and may rotate relative to a rotation shaft 280 provided in the moving plate 180. According to an embodiment of the present disclosure, the transfer unit 80 includes a horizontal transfer part 380, a vertical transfer part 480, and a rotating part 580.

The horizontal transfer part 380 is configured to move the alignment jig 60 in a horizontal direction, or in left and right directions. The horizontal transfer part 380 may move the alignment jig 60 along an x axis. For example, the horizontal transfer part 380 can move the alignment jig 60 mounted on the moving plate 180 in the left and right directions. In an embodiment, the horizontal transfer part 380 is a servomechanism including a servomotor.

The vertical transfer part 480 is configured to adjust the vertical position of the alignment jig 60. The vertical transfer part 480 may move the alignment jig 60 in a direction vertical to the horizontal transfer part 380, that is, in a z axis direction. For example, the vertical transfer part 480 may vertically move the horizontal transfer part 380 on which the alignment jig 60 is mounted. In an embodiment, the vertical transfer part 480 is a servomechanism including a servomotor.

The rotating part 580 is configured to adjust the angle of the alignment jig 60. The alignment jig 60 may be mounted to be rotatable relative to the rotation shaft 280, and the rotating part 580 may adjust the angle of the alignment jig 60 by adjusting the rotation angle of the rotation shaft 280.

Hereinafter, the operation of the battery assembly device according to the present disclosure, particularly, the cooperative operation of the holder unit 40 and the transfer unit 80 will be described.

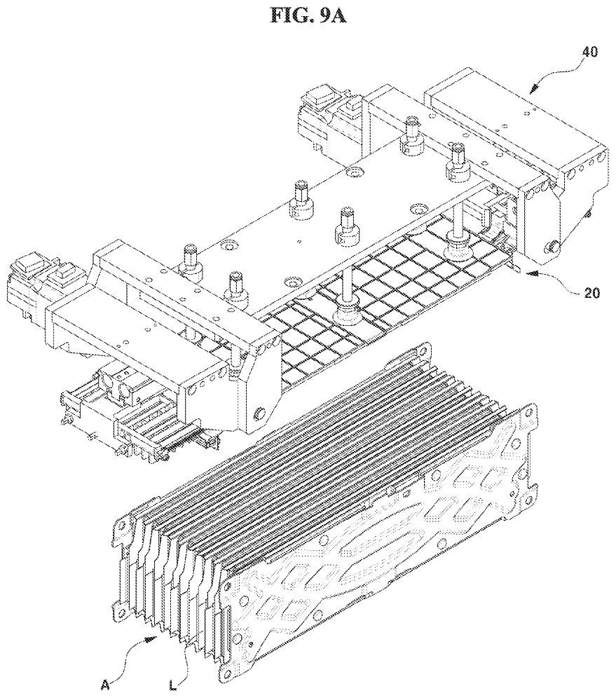

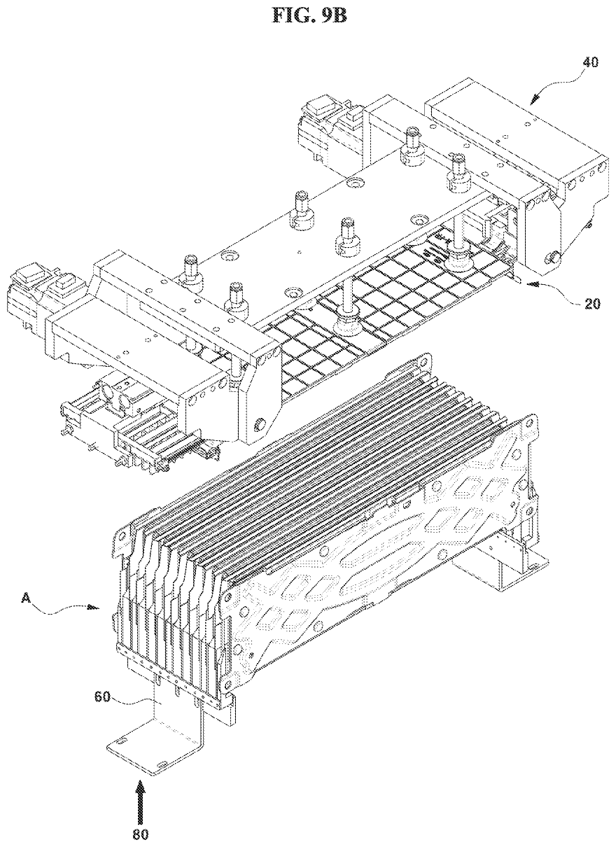

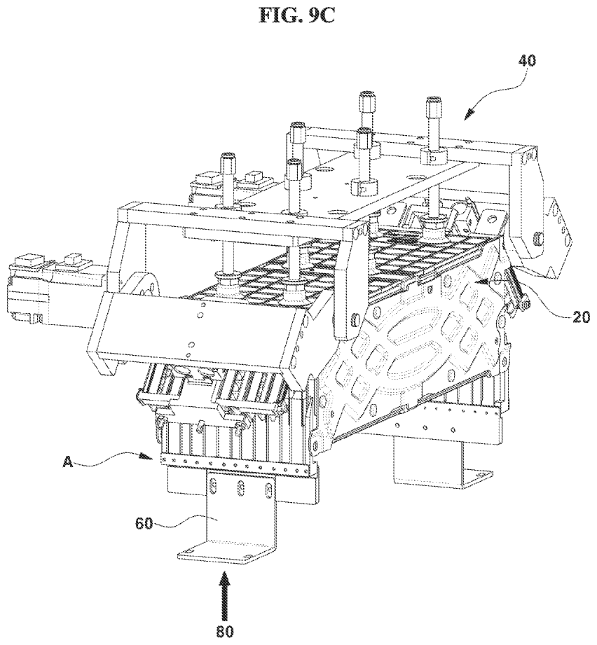

As illustrated in FIG. 9A, the holder unit 40 is configured to transfer and grip the sensing block structure body 20 to be assembled. The holder unit 40 holds the sensing block structure body 20 and moves the sensing block structure body 20 to the upper part of the cell stack A on which the sensing block structure body 20 will be mounted.

In a state in which the holder unit 40 is located on the upper side of the cell stack A while holding the sensing block structure body 20, the transfer unit 80 moves the alignment jig 60 upward. Specifically, the vertical transfer part 480 moves the alignment jig 60 upward to a preset position such that the leads L are engaged with the alignment parts 160. This state is best illustrated in FIG. 9B. However, in FIG. 9B, the transfer unit 80 is omitted, and the transfer unit 80 is located in a part indicated by an arrow.

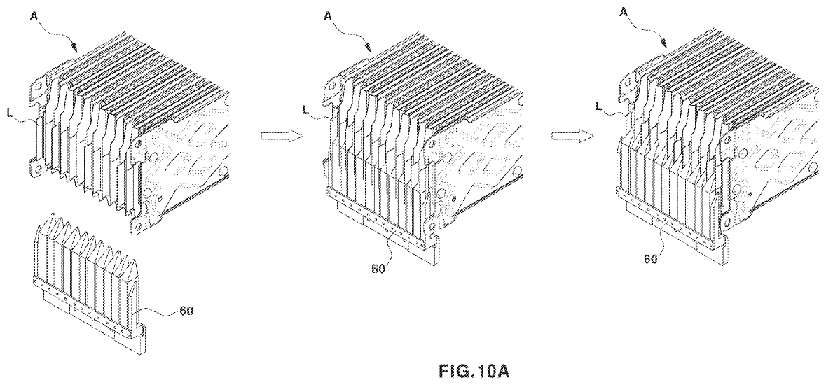

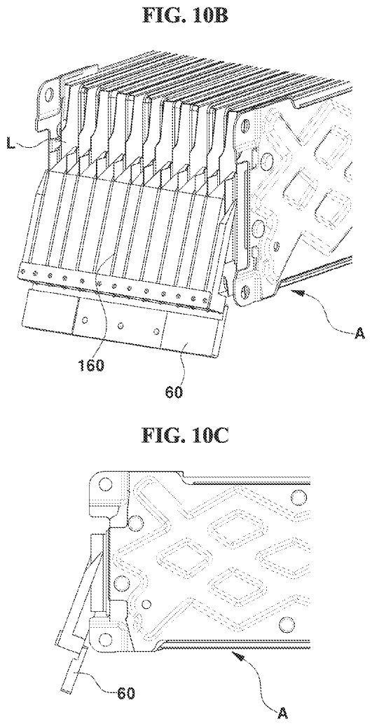

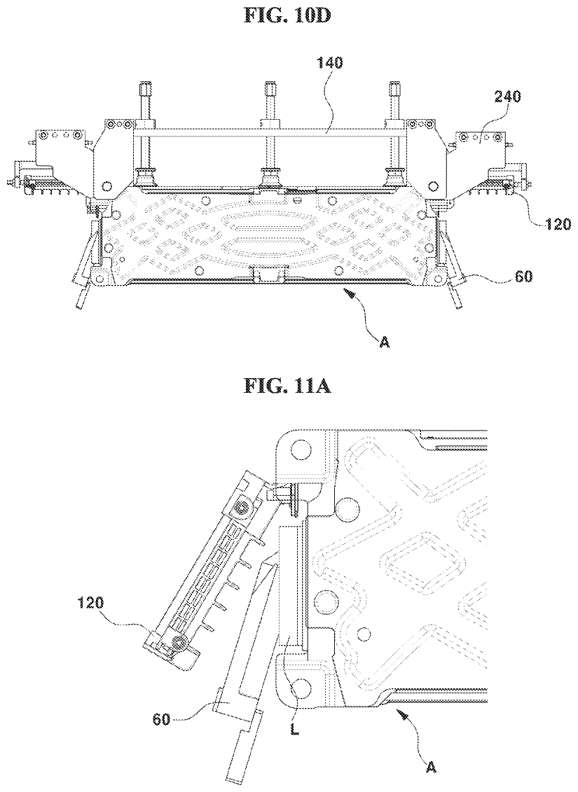

As described above, according to the present disclosure, while the sensing block 120 is being mounted, the alignment jig 60 may maintain the aligned state of the leads L such that the collision of the sensing block with the leads is prevented. This may be realized by cooperative operation of the transfer unit 80 and the holder unit 40 with each other. Referring to FIG. 10A, the alignment jig 60 is moved toward the leads L of the cell stack A by the vertical transfer part 480 (a first figure at the left side of FIG. 10A). The vertical transfer part 480 moves the alignment jig 60 until the leads L are respectively inserted into the alignment parts 160 of the alignment jig 60 so as to align the leads L. In this case, when viewed from the outside of the cell stack A, the leads L protrude to the outside through the alignment parts 160 (a second figured from the left side of FIG. 10A). Next, the horizontal transfer part 380 of the transfer unit 80 moves the alignment jig 60 to the outside of the cell stack A such that the alignment jig 60 is spaced apart by a predetermined distance from the cell stack A. In this case, a portion of the leads L is still located respectively in the alignment parts 160 of the alignment jig 60 (the last figure of FIG. 10A).

Referring to FIGS. 10B and 10C, in the state in which the leads L are respectively located in the alignment parts 160 of the alignment jig 60 although the alignment jig 60 is spaced apart from the cell stack A, the rotating part 580 rotates the alignment jig 60. Specifically, the rotating part 580 rotates the alignment jig 60 such that the tip part of the alignment jig 60 is directed toward the cell stack A. Accordingly, after the alignment jig 60 is rotated, it may be checked from the drawing that a portion of the leads L protrudes to the outside of the alignment jig 60 such that the portion of the leads L is easily seen from the outside. Although the position control of the alignment jig 60 is described at only one side of the cell stack A, the position control of the alignment jig 60 may be performed at each of the opposite sides of the cell stack A as illustrated in FIG. 10D.

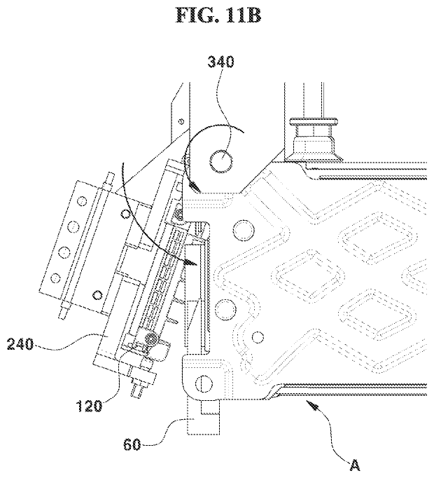

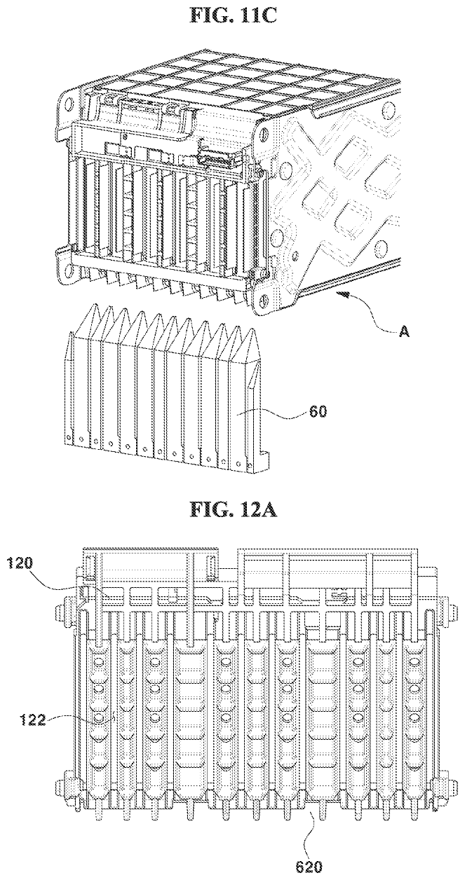

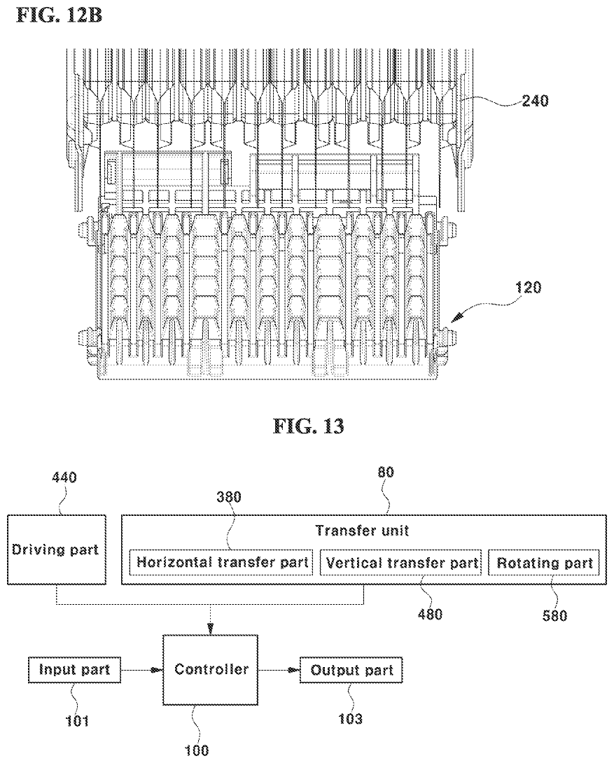

In this state, as illustrated in FIG. 9C, the transfer unit and the holder unit 40 operate together. Specifically, referring to FIGS. 11A to 11C, in the state of FIG. 10C, the grip part 240 is rotated toward the cell stack A relative to the pivot shaft 340. Accordingly, the sensing block 120 gripped by the grip part 240 approaches the cell stack A. The grip part 240 is rotated up to an angle at which the upper ends of the leads L (the parts protruding to the outside through the alignment jig 60) are inserted into the sensing block 120. This angle may be, as a non-limiting example, about 70°. Additionally, FIGS. 12A and 12B illustrate the sensing block 120 viewed from the cell stack A. As illustrated in FIG. 12A, the sensing block 120 is provided with insertion parts 122 into which the leads L are inserted. Furthermore, as illustrated in FIG. 12B, the leads L are respectively inserted into the upper parts of the insertion parts 122 by the rotation of the grip part 240.

In addition, the alignment jig 60 is rotated by the rotating part 580 in a direction in which the lower end part of the alignment jig 60 approaches the cell stack A, and the horizontal transfer part 380 moves the alignment jig 60 such that the alignment jig 60 moves toward the cell stack A and is in substantial contact with the cell stack A. In this case, as illustrated in FIG. 11B, without interfering with the sensing block 120, the alignment jig 60 allows the leads L to be respectively disposed in the alignment parts 160 to align the leads L. While the vertical transfer part 480 gradually moves the alignment jig 60 downward, the grip part 240 rotates to mount the sensing block 120 to the cell stack, and thus the mounting of the sensing block 120 is completed (see FIG. 11C). Accordingly, according to the present disclosure, in the assembly process of the sensing block 120, the interference of the alignment jig 60 with the sensing block 120 does not occur, and during the mounting of the sensing block 120, the alignment jig 60 may always align the leads L.

Referring to FIG. 13, the battery assembly device according to the present disclosure may further include a controller boo. The controller 100 may function to prevent the collisions of the driving part 440 and the transfer unit 80 when servomotors are respectively used in the driving part 440 and the transfer unit 80. In addition, the controller 100 may be configured to control the operations of the driving part 440 and the transfer unit 80.

The controller 100 is configured to communicate with an input part 101 and an output part 103. The controller 100 is configured to receive information from the input part 101, to process the received information, and to output a result through the output part 103. For example, a preset value is input through the input part 101. The preset value may be preset as a servo load factor measured when the driving part 440 or the transfer unit 80 does not collide with parts, such as the leads L.

In addition, the controller 100 is configured to communicate with the driving part 440 and the transfer unit 80. Specifically, the controller 100 may monitor a servo load factor from each of the driving part 440 and the transfer unit 80 in real time. Furthermore, the controller 100 compares the preset value input by the input part mi with the servo load factor which is information received from each of the driving part 440 and the transfer unit 80. Then the controller 100 may determine whether there is collision of each of the driving part 440 and the transfer unit 80. That is, the controller 100 may determine that there is collision when the monitored servo load factor exceeds the preset value which is input in advance.

When the controller 100 determines that there is collision, the controller wo may notify the occurrence of the collision to the outside through the output part 103. As a non-limiting example, the output part 103 may include visual and auditory means. For example, the output part 103 may be a display device or an alarm.

Specifically, when the leads L are not aligned during the rotation of the grip part 240, the grip part 240 or the sensing block 120 may collide with the leads L. The servo load factor of the driving part 440 is collected by the controller 100, and the servo load factor monitored when the collision occurs increases. In this case, the controller wo may notify the collision to a worker through the output part 103.

In addition, during the alignment of the leads L performed by the alignment jig 60, collision therebetween may occur. That is, when the alignment jig 60 moves linearly or rotates, the alignment jig 60 may collide with the leads L. In this case, the servo load factor of the transfer unit 80 is transmitted to the controller 100, and when the collision occurs, the servo load factor which is being detected increases. When the detected servo load factor exceeds a preset value, the controller 100 may determine that there is detected collision and may output an alarm through the output part 103.

The present disclosure described above is not limited by the above-described embodiment and the accompanying drawings, and it will be clear to those skilled in the technical field to which the present disclosure pertains that various substitutions, modifications and changes are possible within the scope without departing from the technical spirit of the present disclosure.

What is claimed is:

1. A battery assembly device comprising:
a holder unit configured to hold a structure and to transfer the structure to a target to be mounted;
an alignment jig operatively associated with the holder unit and configured to align the target; and
a transfer unit configured to provide a moving force to the alignment jig.

2. The battery assembly device of claim 1, wherein the holder unit comprises:
an adsorption part configured to adsorb the structure;
a grip part rotatably connected to the adsorption part and configured to grip a rotatable part of the structure; and
a driving part for providing a rotational force to the grip part.

3. The battery assembly device of claim 2, wherein the holder unit further comprises a pivot shaft which connects the grip part to the adsorption part such that the grip part is rotatable relative to the adsorption part.

4. The battery assembly device of claim 2, wherein the grip part comprises grip rods for holding the structure.

5. The battery assembly device of claim 4, wherein the grip part comprises a first grip part and a second grip part disposed respectively on opposite sides of the adsorption part, wherein grip rods of the first grip part and grip rods of the second grip part are different from each other in number thereof.

6. The battery assembly device of claim 1, wherein the transfer unit comprises:
a horizontal transfer part movably connecting the alignment jig along a horizontal direction; and
a vertical transfer part connecting the horizontal transfer part to be movable along a vertical direction.

7. The battery assembly device of claim 6, wherein the transfer unit further comprises a rotating part for rotating the alignment jig.

8. The battery assembly device of claim 7, wherein the transfer unit further comprises:
a moving plate fixed to the horizontal transfer part; and
a rotation shaft mounted on the moving plate such that the rotation shaft is rotated by the rotating part,
wherein the alignment jig is configured to be rotatable relative to the rotation shaft.

9. The battery assembly device of claim 1, wherein the structure comprises a sensing block structure body, wherein the sensing block structure body comprises:
a link;
a sensing block disposed on each of opposite end parts of the link and electrically connected to the link, the sensing block comprising a first sensing block and a second sensing block; and
a cover disposed on the link such that the sensing block is rotatably coupled to the cover.

10. The battery assembly device of claim 9, wherein the cover comprises a plurality of grooves passing through at least a portion of the cover such that the cover is held by the holder unit.

11. The battery assembly device of claim 9, wherein the sensing block comprises grip holes held by the holder unit, wherein grip holes of the first sensing block and grip holes of the second sensing block are different from each other in number thereof.

12. A battery assembly device comprising:
a holder unit configured to grip at least one sensing block of two sensing blocks connected to each other such that the at least one sensing block is rotatable relative to a pivot shaft;
an alignment jig configured to align leads of a cell stack in which a plurality of battery cells is stacked;
a transfer unit to which the alignment jig is movably mounted; and
a controller configured to control operations of the holder unit and the transfer unit,
wherein the controller is configured to control the holder unit and the transfer unit such that the alignment jig aligns the leads while the leads are inserted into the sensing block.

13. The battery assembly device of claim 12, wherein the holder unit comprises:
a grip part configured to grip the sensing block such that the grip part is rotatable relative to the pivot shaft; and
a driving part which provides a rotational force to the grip part.

14. The battery assembly device of claim 13, wherein the transfer unit comprises:
a horizontal transfer part to which the alignment jig is mounted such that the alignment jig is movable along a horizontal direction;
a vertical transfer part to which the alignment jig is mounted such that the alignment jig is movable in a vertical direction; and
a rotating part to which the alignment jig is mounted such that the alignment jig is rotatable.

15. The battery assembly device of claim 14, wherein each of the driving part, the horizontal transfer part, the vertical transfer part, and the rotating part comprises a servomotor.

16. The battery assembly device of claim 15, wherein the controller is configured to measure a servo load factor of the servomotor in real time and to determine whether a current servo load factor of the servomotor which is measured in real time exceeds a preset servo load factor.

17. The battery assembly device of claim 16, further comprising:
an output part capable of communicating with the controller,
wherein when the current servo load factor exceeds the preset servo load factor, the controller generates an alarm through the output part.

18. A method of operating a battery assembly device comprising a holder unit configured to grip at least one sensing block of two sensing blocks connected to each other such that the at least one sensing block is rotatable relative to a pivot shaft; an alignment jig configured to align leads of a cell stack in which a plurality of battery cells is stacked; a transfer unit to which the alignment jig is movably mounted; and a controller configured to control operations of the holder unit and the transfer unit, wherein the controller is configured to control the holder unit and the transfer unit such that the alignment jig aligns the leads while the leads are inserted into the sensing block; wherein the holder unit comprises a grip part which grips the sensing block such that the grip part is rotatable relative to the pivot shaft and a driving part which provides a rotational force to the grip part; and wherein the transfer unit comprises a horizontal transfer part to which the alignment jig is mounted such that the alignment jig is movable along a horizontal direction, a vertical transfer part to which the alignment jig is mounted such that the alignment jig is movable in a vertical direction, and a rotating part to which the alignment jig is mounted such that the alignment jig is rotatable, the method comprising:
raising, by the controller, the alignment jig to the leads by driving the vertical transfer part;
rotating, by the controller, the alignment jig such that a tip part of the alignment jig faces the leads by driving the rotating part;
rotating, by the controller, the sensing block toward the leads by driving the driving part;
rotating, by the controller, the alignment jig such that the alignment jig is parallel to the leads by driving the rotating part; and
lowering, by the controller, the alignment jig by driving the vertical transfer part while rotating the sensing block toward the leads by driving the driving part.

19. The method of claim 18, further comprising:
after the raising of the alignment jig, spacing the alignment jig apart from the leads to an outside thereof by driving the horizontal transfer part, and
after the rotating of the alignment jig such that the alignment jig is parallel to the leads, moving the alignment jig to the leads by driving the horizontal transfer part.
